(19) United States
(12) Patent Application Publication
(10) Pub. No.: US 2023/0298608 A1
(43) Pub. Date: Sep. 21, 2023

(54) SOUND PROCESSING DEVICES AND CORRESPONDING METHODS AND COMPUTER PROGRAMS

(71) Applicant: Sony Group Corporation, Tokyo (JP)

(72) Inventors: Thomas CARETTE, Stuttgart (DE); Alexandru SERBANATI, Stuttgart (DE)

(73) Assignee: Sony Group Corporation, Tokyo (JP)

(21) Appl. No.: 18/180,857

(22) Filed: Mar. 9, 2023

(30) Foreign Application Priority Data
Mar. 15, 2022 (EP) 22162192.3

(51) Int. Cl. G10L 21/02

(52) U.S. Cl. CPC G10L 21/02

(57) ABSTRACT

Examples relate to sound processing devices, to corresponding methods and computer programs for sound processing devices, and to devices, such as mobile devices or hearing aids, comprising a sound processing device. A sound processing device comprises at least one interface for communicating with one or more further sound processing devices. The sound processing device comprises processing circuitry, configured to obtain a sound processing model. The processing circuitry is configured to receive, from the one or more further sound processing devices, one or more local adjustments to the sound processing model determined by the one or more further sound processing devices based on sound recorded locally by the one or more further sound processing devices. The processing circuitry is configured to adjust the sound processing model based on the one or more local adjustments. The processing circuitry is configured to process sound recorded locally by the sound processing device using the sound processing model.

### CROSS-REFERENCE TO RELATED APPLICATION

This application claims priority to European Application No. 22162192.3, filed Mar. 15, 2022, the entire contents of which are incorporated herein by reference.

### FIELD

Examples relate to sound processing devices, to corresponding methods and computer programs for sound processing devices, and to devices, such as mobile devices or hearing aids, comprising a sound processing device.

### BACKGROUND

With the proliferation of audio-recording devices, it is now conceivable that any moderately frequented public place will have multiple devices recording overlapping spaces simultaneously at any time. However, these devices do no collaborate to record the surrounding soundscape so that a lot of useful information is lost in the process. For example, sound triangulation, 3D reconstruction or source-specific de-noising are processes with wide range of applications and are usually enabled by recording the same signal with multiple spatially separated microphones.

There may be a desire for an improved concept for processing sound recorded by a sound processing device.

### SUMMARY

This desire is addressed by the subject-matter of the independent claims.

Various examples of the present disclosure are based on the finding, that a sound processing device can collaborate with one or more further sound processing devices without exchanging the actual recorded sound in a peer-to-peer fashion, which may carry a high communication load and privacy risks due to the local recording of speech and sound features that can betray a position of the respective further sound processing devices. Instead, the respective sound processing devices can employ a distributed learning algorithm on a sound processing model being used by one of the sound processing devices. In the distributed learning algorithm, the further sound processing devices (also called “helper devices”) determine local adjustments to the sound processing model that are based on the sound that they perceive locally and share these local adjustments with the sound processing device (called “main device”) using the sound processing model to process sound. In various examples of the present disclosure, the main device uses the sound processing model to perform a given sound processing task. This task may be communicated to the helper devices, so helper devices know what aspect of the sound processing model to adjust.

Various examples of the present disclosure relate a sound processing device (e.g., the main device). The sound processing device comprises at least one interface for communicating with one or more further sound processing devices (e.g., the one or more helper devices). The sound processing device comprises processing circuitry, configured to obtain a sound processing model. The processing circuitry is configured to receive, from the one or more further sound processing devices, one or more local adjustments to the sound processing model determined by the one or more further sound processing devices based on sound recorded locally by the one or more further sound processing devices. The processing circuitry is configured to adjust the sound processing model based on the one or more local adjustments. The processing circuitry is configured to process sound recorded locally by the sound processing device using the sound processing model. This enables a cooperation of the sound processing device with the one or more further sound processing devices without exchanging the actual sound recorded by the sound processing devices.

For example, the processing circuitry may be configured use the sound processing model to perform a sound processing task. The processing circuitry may be configured to provide information on the sound processing task to the one or more further sound processing devices. The one or more local adjustments may be determined based on the sound processing task. If the further sound processing devices are aware of the sound processing task, they can determine adjustments that are relevant with respect to the sound processing tasks.

The processing circuitry may be configured to repeatedly receive updates to the one or more local adjustments from at least a subset of the one or more further sound processing devices. Accordingly, the processing circuitry may be configured to repeatedly adjust the sound processing model based on the repeatedly received updates to the one or more local adjustments. By continuously exchanging updates, the sound processing model may be iteratively refined and/or adjusted to changes in the sound landscape.

While cooperation between sound processing devices can be valuable, some sound processing devices may be more useful than others during the adjustment of the sound processing model. For example, the processing circuitry may be configured to determine a usefulness of the one or more local adjustments for the sound processing device, and to ignore or cease receiving updates from another sound processing device based on the usefulness of the local adjustment of the other sound processing device for the sound processing device. This may reduce a communication and processing overhead for the sound processing device and may avoid the adjustments degrading the sound processing model.

The proposed concept is particularly suitable for scenarios with a continuously evolving soundscape. Changes in the soundscape can, via the local adjustments, be propagated so the main device can, in real-time or near real-time, profit from the results of the distributed learning. For example, the processing circuitry may be configured to perform real-time processing or near-real-time processing of the sound recorded by the sound processing device using the sound processing model.

There are various viable sources for obtaining the sound processing model. For example, the processing circuitry may be configured to obtain the sound processing model from a central registry. For example, the central registry may be used to make up-to-date sound processing models available for multiple sound processing devices, so that the sound processing devices can profit from distributed learning performed by different devices.

Alternatively, the processing circuitry may be configured to obtain the sound processing model from another sound processing device, or the processing circuitry may be configured to generate the sound processing model. In this case, a peer-to-peer model can be used, so that no central registry is required. For example, the processing circuitry may be configured to provide the sound processing model (that is obtained from the central registry, from another sound processing device, or generated locally) to the one or more further sound processing devices.

The main device may actively request the helper devices to provide the adjustments or the sound processing model. For example, the processing circuitry may be configured to provide one or more requests to the one or more further sound processing devices to provide the one or more local adjustments and/or the sound processing model. Accordingly, the adjustments and/or sound processing model may be provided as needed by the main device.

The proposed concept is focused on processing audio in a given environment. In particular, the local adjustments may be useful to the main device if they originate from sound processing devices in the same environment as the main device. For example, the further sound processing devices in the environment of the main device may be learned from the central registry. The processing circuitry may be configured to obtain information on a presence of sound processing devices in a general location of the sound processing device from a central registry, and to provide the one or more requests based on the information on the presence of the sound processing devices in the general location of the sound processing device. Alternatively, a peer-to-peer approach may be used. For example, the processing circuitry may be configured to determine a presence of the one or more further sound processing devices in the general location of the sound processing device, and to provide the one or more requests based on the determination of the presence of the one or more further sound processing devices.

As pointed out above, the processing circuitry may be configured to perform distributed learning using the one or more local adjustments to adjust the sound processing model. For example, the distributed learning may be based on integrating the local adjustments proposed by the one or more further sound processing devices.

In general, care may be taken to take into account privacy considerations in the distributed learning process. For example, the local adjustments may be collected such, that the privacy of the owner(s) of the one or more further sound processing devices (and nearby audio sources) is not violated. This can be done by defining (e.g., training) embeddings, which, in this case, are functions that define an alteration of the sound processed locally (or of the adjustments to the sound processing model) that is performed in order to alter (e.g., obfuscate) at least one aspect of the sound recorded locally. For example, the one or more local adjustments may be based on one or more embeddings designed to alter at least one aspect of the sound recorded locally, such as an impact of local speech or an impact of a location of the respective further sound processing device.

In addition, or alternatively, the local adjustments may be limited by a differential privacy algorithm. For example, the one or more local adjustments may be based on a privacy budget imposed by a differential privacy algorithm.

In the present disclosure, a sound processing model is used to process the sound recorded locally by the main device. However, the term sound processing model is not to be understood in a limited fashion. In various examples, multiple layers of sound processing models may be used to process the sound. For example, the processing circuitry may be configured to process the sound recorded locally using the sound processing model and using a second sound processing model, with the sound processing model being a task-agnostic sound processing model and the second sound processing model being a task-specific sound processing model. For example, the task-agnostic model, which may provide a more general improvement of the sound processing, may be adjusted based on the one or more local adjustments.

In some scenarios, a third sound processing layer may be added, such as a further task-specific sound processing model that is adjusted based on adjustments proposed by the one or more further sound processing devices. For example, the processing circuitry may be configured to process the sound recorded locally further using a third sound processing model, with the third sound processing model being a task-specific sound processing model. The processing circuitry may be configured to receive, from the one or more further sound processing devices, one or more further local adjustments to the third sound processing model determined by the one or more further sound processing devices based on sound recorded locally by the one or more further sound processing devices, and to adjust the third sound processing model based on the one or more further local adjustments. This may enable or improve task-specific adjustments to the sound processing performed by the main device.

Various examples of the present disclosure further provide another device comprising the sound processing device (i.e., the main device), such as a hearing aid comprising the sound processing device or a mobile communication device (e.g., a smartphone or smartwatch) comprising the sound processing device.

Various examples of the present disclosure relate to a corresponding method for a sound processing device (i.e., for the main device). The method comprises obtaining a sound processing model. The method comprises receiving, from one or more further sound processing devices, one or more local adjustments to the sound processing model performed by the one or more further sound processing devices based on sound recorded locally by the one or more further sound processing devices. The method comprises adjusting the sound processing model based on the one or more local adjustments. The method comprises processing sound recorded locally by the sound processing device using the sound processing model.

Various examples of the present disclosure relate to a corresponding computer program having a program code for performing the above method (for the main device), when the computer program is executed on a computer, a processor, or a programmable hardware component.

Various examples of the present disclosure relate to another sound processing device (i.e., the helper device). The sound processing device comprises at least one interface for communicating with a further sound processing device (i.e., the main device). The sound processing device comprises processing circuitry, configured to obtain a sound processing model. The processing circuitry is configured to obtain information on a sound processing task being performed by the further sound processing device. The processing circuitry is configured to determine a local adjustment to the sound processing model based on sound recorded locally by the sound processing device and based on the sound processing task being performed by the further sound processing device. The processing circuitry is configured to provide the local adjustment to the further sound processing device. Thus, the helper device may participate in distributed learning with the further sound processing device (i.e., the main device).

As outlined in relation to the main device, the helper device may provide frequent updates to the local adjustment. For example, the processing circuitry may be configured to repeatedly determine updates to the local adjustment to the sound processing model based on newly recorded sound recorded by the sound processing device, and to provide the updates to the further sound processing device. Thus, the sound processing model may be iteratively refined and/or adapted to a changing soundscape.

For example, in a scenario with a central registry, the processing circuitry may be configured to obtain the sound processing model from a central registry. Alternatively, in a peer-to-peer scenario, the processing circuitry may be configured to obtain the sound processing model from another sound processing device.

The local adjustment may be requested by the main device. Accordingly, the processing circuitry may be configured to receive a request for the local adjustment from the further sound processing device, and to provide the local adjustment in response to the request. Thus, the main device may control whether to obtain local adjustment(s) from a helper device.

As outlined above, the determination of the local adjustment may be part of distributed learning. For example, the distributed learning may be focused on the main device integrating the local adjustments proposed by the helper devices.

As shown in connection with the main device, care may be taken to take into account privacy considerations in the distributed learning process. For example, the processing circuitry may be configured to apply one or more embeddings designed to alter at least one aspect of the sound recorded locally, such as an impact of local speech or an impact of a location of the respective further sound processing device. Alternatively, or additionally, the processing circuitry may be configured to determine the local adjustment based on a privacy budget of a differential privacy algorithm.

In some examples, the main device uses multiple layers of sound processing models to process the sound. In particular, the main device may use a task-agnostic sound processing model and one or more task-specific sound processing models. In some cases, the helper device may participate in distributed learning to improve a task-specific model (in addition to the task-agnostic sound processing model). For example, the sound processing model may be a task-agnostic sound processing model. The processing circuitry may be configured to obtain a task-specific sound processing model, to determine a further local adjustment to the task-specific sound processing model based on the sound recorded locally by the sound processing device, and to provide the further local adjustment to the further sound processing device.

Various examples of the present disclosure further provide another device comprising the sound processing device (i.e., the helper device), such as a hearing aid comprising the sound processing device or a mobile communication device (e.g., a smartphone or smartwatch) comprising the sound processing device.

Various examples of the present disclosure relate to a corresponding method for a sound processing device (i.e., for the helper device). The method comprises obtaining a sound processing model. The method comprises obtaining information on a sound processing task being performed by a further sound processing device. The method comprises determining a local adjustment to the sound processing model based on sound recorded locally by the sound processing device and based on the sound processing task being performed by the further sound processing device. The method comprises providing the local adjustment to the further sound processing device.

Various examples of the present disclosure relate to a corresponding computer program having a program code for performing the above method (for the helper device), when the computer program is executed on a computer, a processor, or a programmable hardware component.

### BRIEF DESCRIPTION OF THE FIGURES

Some examples of apparatuses and/or methods will be described in the following by way of example only, and with reference to the accompanying figures, in which

FIG. 1a shows a block diagram of an example of a sound processing device (main device) and of a system comprising the sound processing device and one or more further sound processing devices (helper devices);

FIG. 1b shows a flow chart of an example of a method for a sound processing device (main device);

FIG. 2a shows a block diagram of an example of a sound processing device (helper device) and of a system comprising the sound processing device and a further sound processing device (main device);

FIG. 2b shows a flow chart of an example of a method for a sound processing device (helper device);

FIG. 3 shows a schematic diagram of an example of a distributed learning approach applied on sound processing devices;

FIG. 4 shows a schematic diagram of an example of a spatial relationship between sound sources and sound processing devices;

FIG. 5a shows a flow chart of an example of a setup process for distributed learning; and

FIG. 5b shows a flow chart of an example of a training process for distributed learning.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

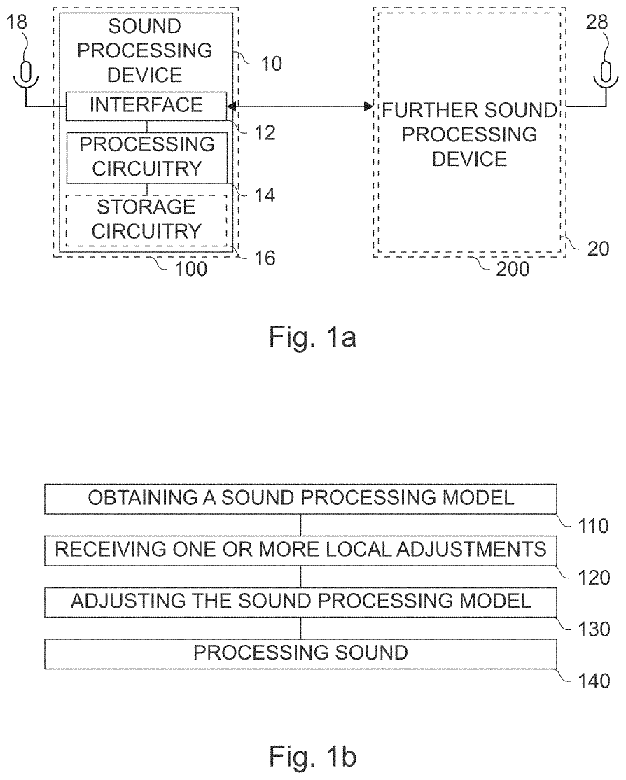

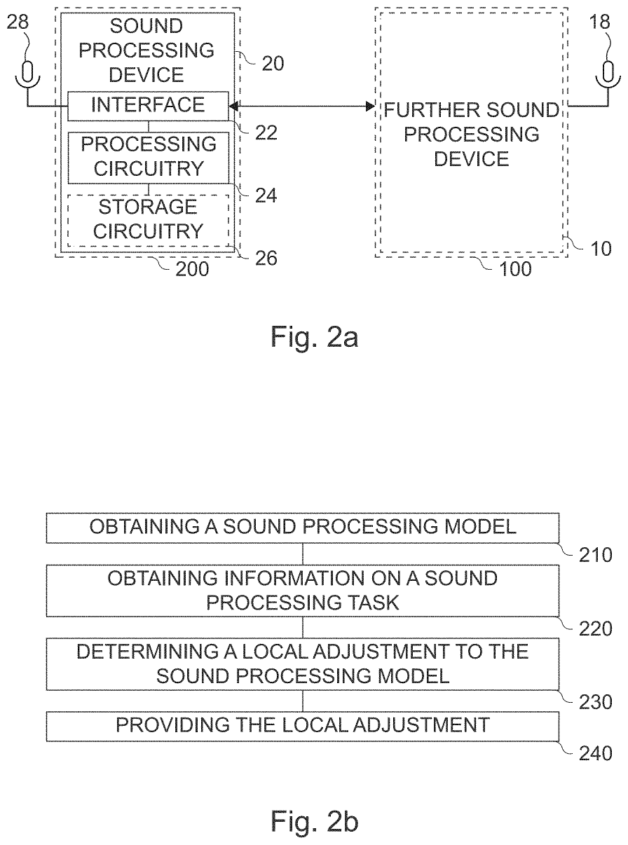

In FIGS. 1a and 2a, two sound processing devices 10; 20 are shown, of which one is also referred to as main device (the sound processing device 10 of FIG. 1a), and the other (or others) is/are referred to as helper device(s) (the sound processing device 20 of FIG. 2). The two devices form a system, with one main device 10 being helped by one or more (e.g., multiple) helper devices 20. In particular, the main device 10 and the helper devices 20 may perform distributed learning, in order to adjust a sound processing model being used by the main device. In the following, the two sound processing devices are first described individually, followed by a discussion of the interaction between the two sound processing devices.

FIG. 1a shows a block diagram of an example of a sound processing device 10 (also called the main device 10) and of a system comprising the main device 10 and one or more helper devices 20 (helper devices 20). The main device 10 comprises at least one interface 12 and processing circuitry 14, which is coupled to the at least one interface 12. The main device may further comprise storage circuitry 16, which may also be coupled to the processing circuitry 14. In general, the functionality of the main device 10 is provided by the processing circuitry 14, with the help of the at least one interface 12 (for communicating, e.g., with the one or more helper devices, with a central registry, or with a microphone 18), and/or with the help of the storage circuitry 16 (for storing and/or retrieving information, such as a sound processing model). The processing circuitry 14 is configured to obtain a sound processing model. The processing circuitry 14 is configured to receive (via the at least one interface 12), from the one or more helper devices, one or more local adjustments to the sound processing model determined by the one or more helper devices based on sound recorded locally by the one or more helper devices. The processing circuitry 14 is configured to adjust the sound processing model based on the one or more local adjustments. The processing circuitry 14 is configured to process sound recorded locally by the main device using the sound processing model. For this purpose, the main device 10 (or a device 100 comprising the main device 10) may comprise a microphone 18, which may be coupled with the at least one interface 12. The processing circuitry 14 may be configured to record the sound using the microphone 18.

FIG. 1a further shows a device 100 comprising the main device 10. For example, the device 100 may be any device that would benefit from information on local sound sources that can be provided by the one or more helper devices. For example, the device 100 may be a hearing aid (or pair of hearing aids), a noise-cancelling headphone, or a mobile communication device, such as a smartphone or smartwatch.

FIG. 1b shows a flow chart of an example of a corresponding method for the main device. The method comprises obtaining 110 a sound processing model. The method comprises receiving 120, from one or more helper devices, one or more local adjustments to the sound processing model performed by the one or more helper devices based on sound recorded locally by the one or more helper devices. The method comprises adjusting 130 the sound processing model based on the one or more local adjustments. The method comprises processing 140 sound recorded locally by the main device using the sound processing model. For example, the method may be performed by the main device 10, e.g., by the processing circuitry 14 of the main device, with the help of the at least one interface 12 (for communicating) and/or the optical processing circuitry 16 (for storing and/or retrieving information). Features that are discussed in connection with the main device or with the system comprising the main device and the one or more helper devices may likewise be included in the corresponding method (and in a corresponding computer program).

FIG. 2a shows a block diagram of an example of a helper device 20 (i.e., a sound processing device of the one or more further sound processing devices 20) and of a system comprising the helper device 20 and the main device 10. The helper device 20 comprises at least one interface 22 and processing circuitry 24, which is coupled to the at least one interface 22. The helper device may further comprise storage circuitry 26, which may also be coupled to the processing circuitry 24. In general, the functionality of the helper device 20 is provided by the processing circuitry 24, with the help of the at least one interface 22 (for communicating, e.g., with the main device, with a central registry, or with a microphone 28), and/or with the help of the storage circuitry 26 (for storing and/or retrieving information, such as a sound processing model). The processing circuitry 24 is configured to obtain a sound processing model. The processing circuitry 24 is configured to obtain information on a sound processing task being performed by the further sound processing device. The processing circuitry 24 is configured to determine a local adjustment to the sound processing model based on sound recorded locally by the sound processing device and based on the sound processing task being performed by the further sound processing device. The processing circuitry 24 is configured to provide the local adjustment to the further sound processing device. For example, the helper device 20 (or a device 200 comprising the helper device 20) may comprise a microphone 28, which may be coupled with the at least one interface 22. The processing circuitry 24 may be configured to record the sound using the microphone 28.

FIG. 2a further shows a device 200 comprising the main device 10. For example, the device 200 may be any device that would benefit from information on local sound sources that can be provided by the one or more helper devices. For example, the device 200 may be a hearing aid (or pair of hearing aids), a noise-cancelling headphone, or a mobile communication device, such as a smartphone or smartwatch.

FIG. 2b shows a flow chart of an example of a corresponding method for the helper device. The method comprises obtaining 210 a sound processing model. The method comprises obtaining 220 information on a sound processing task being performed by a further sound processing device. The method comprises determining 230 a local adjustment to the sound processing model based on sound recorded locally by the sound processing device and based on the sound processing task being performed by the further sound processing device. The method comprises providing 240 the local adjustment to the further sound processing device. For example, the method may be performed by the helper device 20, e.g., by the processing circuitry 24 of the helper device, with the help of the at least one interface 22 (for communicating) and/or the optical processing circuitry 26 (for storing and/or retrieving information). Features that are discussed in connection with the helper device or with the system comprising the helper device and the main device may likewise be included in the corresponding method (and in a corresponding computer program).

As is evident, the main device 10 and the one or more helper devices 20 interact with each other, with the main device 10, with the helper devices determining local adjustments to a sound processing model, and with the main device using said adjustments to adjust the sound processing model, and to process sound using the adjusted sound processing model. In effect, the main device 10 and the one or more helper devices 20 may perform distributed learning, with the main device 10 reaping the benefits of the distributed learning process. For example, the processing circuitry of the main device may be configured to perform distributed learning using the one or more local adjustments to adjust the sound processing model. Similarly, the determination of the local adjustment performed by the one or more helper devices may be part of distributed learning. For example, the processing circuitry 14 of the main device 10 may share the result of the distributed learning, e.g., the adjusted sound processing model, with a central registry or with the one or more helper devices. In the following, the collaboration between the two types of devices is shown in more details.

On both sides, the actions being performed are based on the sound processing model, which is being obtained by the respective processing circuitry. In general, the sound processing model may be any set of instructions for transforming sound recorded by the respective sound processing device. For example, the sound processing model may comprise a set of labelled audio filters. For example, adjustments to the sound processing devices may relate to parameters of the set of labelled audio filters. The sound processing model may be used to transform the sound recorded locally by the respective sound processing device, e.g., with the purpose of improving an aspect of the sound, e.g., by suppressing noise, or by making voices better understandable.

To obtain the model, two different approaches may be used—a centralized approach, and a decentralized approach. In the centralized approach, the sound processing model may be hosted and provided by a central registry. Accordingly, the processing circuitry of the main device may be configured to obtain the sound processing model from the central registry. Similarly, the processing circuitry of the helper device may be configured to obtain the sound processing model from the central registry. For example, the central registry may be server, e.g., an edge server that covers a pre-defined coverage area (with the main device and/or the one or more helper devices being located in the coverage area). For example, the central registry may be hosted by a provider of a mobile communication system, e.g., by a provider of a cellular mobile communication system or by a hotspot provider.

In the decentralized approach, the sound processing model may be shared among sound processing devices. For example, a decentralized registry may be maintained among the sound processing device using a peer-to-peer communication approach. For example, the processing circuitry of the main device and/or the processing circuitry of the helper device may be configured to obtain the sound processing model from another sound processing device. For example, the processing circuitry of the main device may be configured to obtain the sound processing model from another sound processing device, and to forward the sound processing model to the one or more helper devices. Alternatively, the processing circuitry of the main device may be configured to generate the sound processing model (e.g., based on the sound processing task it is trying to accomplish), and to provide the generated sound processing model to the one or more further sound processing devices.

In general, the main device uses the sound processing model to perform a sound processing task. For example, the main device may use the sound processing model to suppress noise, or to isolate some components of the sound (e.g., voices). Information on the sound processing task may be shared by the main device with the one or more helper devices (if it is not inherent to the sound processing model). For example, the processing circuitry of the main device may be configured to provide information on the sound processing task to the one or more helper devices. Accordingly, the processing circuitry of the helper device may be configured to obtain information on a sound processing task being performed by the main device, which it uses to determine the one or more local adjustments. For example, the processing circuitry of the main device may be configured to compile a sample of sound recorded locally by the main device (and anonymize the sample, e.g., using embeddings), and to provide a task identifier and the sample as information on the task being performed by the main device to the one or more helper devices. For example, the processing circuitry of the main device may be configured to periodically update the sample of sound recorded locally by the main device, and to provide updates of the sample to the one or more helper devices.

In general, the proposed concept is based on the main device inviting the helper devices to collaborate in the distributed learning process. For this purpose, the main device may identify suitable helper devices, e.g., based on their location or willingness to cooperate. Again, a centralized or decentralized may be chosen. For example, the (potential) helper devices may be identified by or via the central registry. For example, the processing circuitry of the main device may be configured to obtain information on a presence of sound processing devices in a general location of the sound processing device from the central registry. For example, the central registry may track a (general) location of the sound processing device, and to determine helper devices that are in the same general location of the main based on their location. Alternatively, a peer-to-peer-approach may be used. The processing circuitry of the main device may be configured to determine the presence of the one or more further sound processing devices in the general location of the sound processing device. For example, the processing circuitry of the main device may be configured to broadcast a request for helper devices to respond if they are in the same general location of the main device. For example, two sound processing devices may be in the same general location if a distance between the two sound processing device is at most 25 meters (or at most 50 meters, or at most 100 meters, or at most 200 meters) or if the two sound processing devices are within the same space (e.g., courtyard, concert hall, open air performing arts venue, public transport platform etc.).

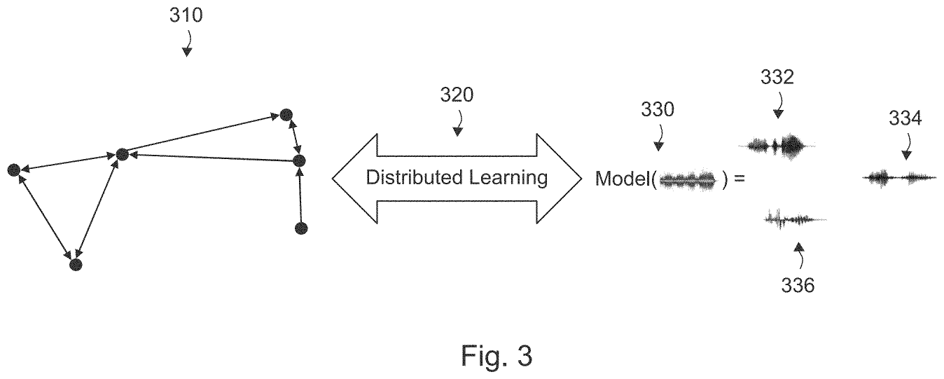

In some examples, the central registry or the processing circuitry of the main device may organize the one or more helper devices in a directed graph (as shown in FIG. 3), which may define a network of contributors to the distributed learning.

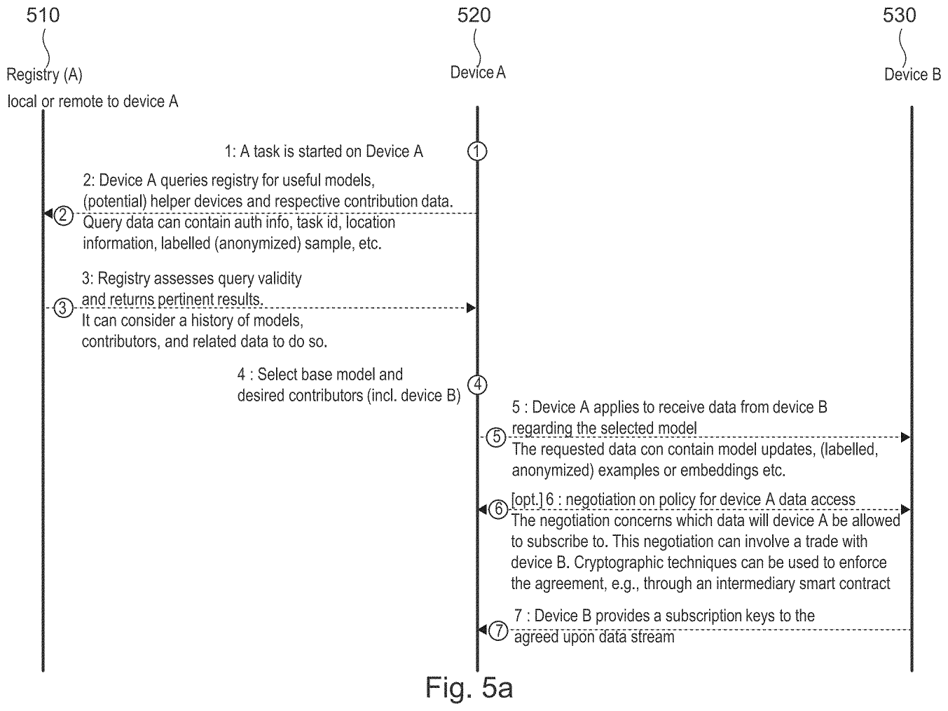

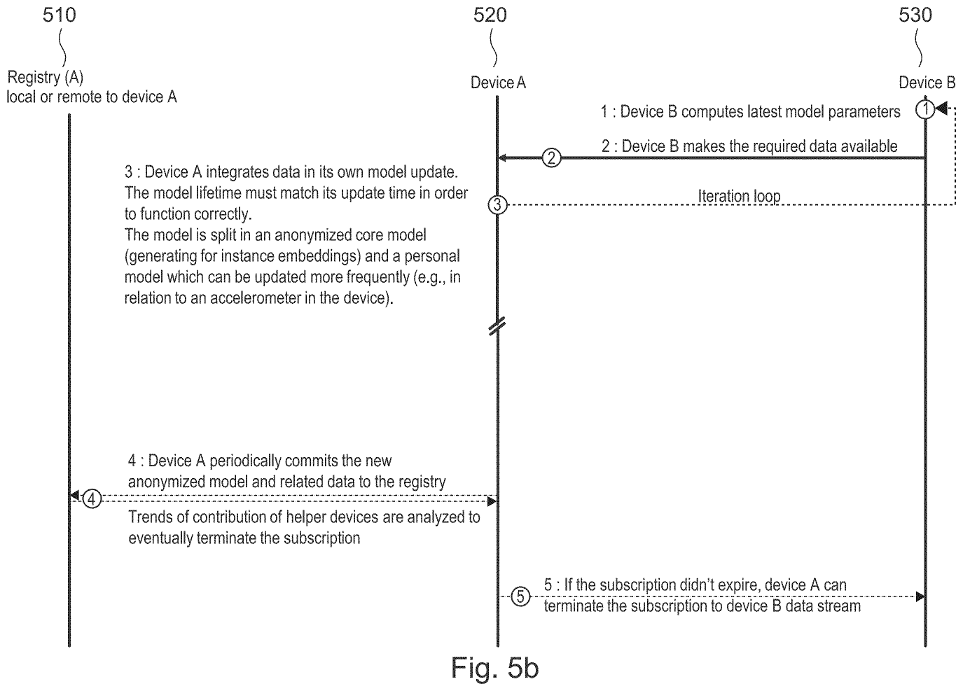

Once suitable helper device(s) are identified, the main device may request the one or more helper devices to participate in the distributed learning effort. For example, the processing circuitry of the main device may be configured to provide one or more requests to the one or more helper devices to provide the one or more local adjustments and/or the sound processing model. For example, the one or more requests may be provided to the one or more helper devices based on their presence in the general location of the main device, i.e., based on the information on the presence of the sound processing devices in the general location of the sound processing device. Accordingly, the processing circuitry of the helper device may be configured to receive a request for the local adjustment from the further sound processing device (e.g., based on the presence of the helper device in the general location of the main device), and to provide the local adjustment in response to the request. In some cases, e.g., as shown in FIG. 5a, point (6), the main device and the one or more helper devices may negotiate regarding the provision of the local adjustments.

The core of the proposed concept is the determination of the local adjustments by the helper devices. The local adjustment determined by the respective helper device may be considered the contribution of the helper in the distributed learning being performed. For example, the distributed learning may be performed using different techniques, e.g., centralized techniques such as Federated Learning, or decentralized techniques such as Multi-Party Computation (MPC) or Fully Decentralized Learning.

For example, if Federated Learning is used, the sound processing model may be the “global” model being trained, with the model being trained by the helper devices using the sound recorded locally by the helper devices (and the sample of sound provided by the main device, e.g., to test the suitability of the proposed local adjustments). If the sound processing model is implemented using a neural network, the adjusted weights of the neural network may be provided as local adjustment to the main device. If the sound processing model is implemented using a set of audio filters, the parameters of the set of audio filters being changed by the local adjustment may be provided to the main device. Fully decentralized learning may be considered similar to federated learning, albeit without the data being collected centrally, but at each participant of the decentralized learning approach.

In Multi Party Computation, multiple participants (e.g., the main device and the one or more helper devices) each have private data (e.g., the sound recorded locally), which they use to jointly compute the value of a public function using the private data without revealing the private data. For example, a secret sharing scheme, such as Shamir secret sharing or additive secret sharing, may be used to adjust the sound processing model (by the main device), with the local adjustments being the shared secrets of the one or more helper devices.

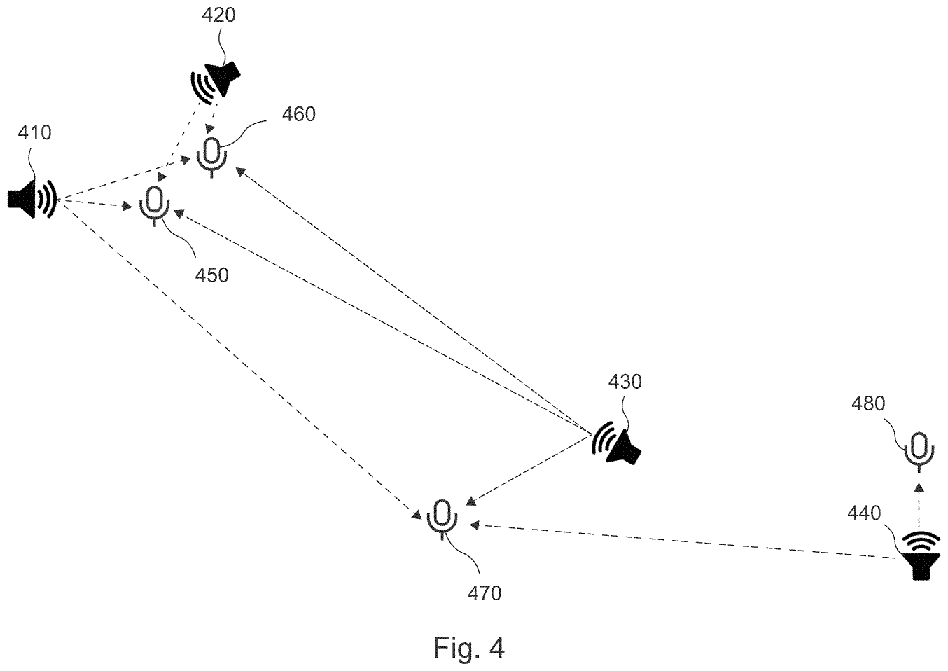

The processing circuitry of the helper device is configured to determine the local adjustment to the sound processing model based on sound recorded locally by the sound processing device and based on the sound processing task being performed by the further sound processing device. In other words, the processing circuitry of the helper device may be configured to determine the local adjustment to the sound processing model such, that the main device is supported in carrying out the sound-processing task by the local adjustment. For example, the processing circuitry of the helper device may use the sample of sound recorded locally by the main device to evaluate the local adjustment with respect to the sound processing task, e.g., to determine whether the local adjustment is beneficial with respect to the sound processing task (e.g., beneficial with respect to the suppression of noise or beneficial with respect to the isolation of voices). To give an example, which is illustrated in more detail in connection with FIG. 4, the main device may have the task of distinguishing two sound sources (410 and 420 in FIG. 4) or to suppress background noise of a sound source (430 in FIG. 4) that is located closer to a helper device (470 in FIG. 4). The respective helper devices (e.g., helper devices 460 and 470) may be tasked with providing local adjustments to the sound processing model used by main device 450 that allow said device to distinguish the sound sources 410 and 420 (as one task), or to allow said device to suppress the noise generated by sound source 430 (as another task. The processing circuitry of the respective helper device may use the sample of sound provided by the main device to evaluate whether the local adjustment serves this task. Once the local adjustment is determined, the processing circuitry of the respective helper device provides the local adjustment to the further sound processing device (e.g., via the interface 24).

On the side of the main device, the processing circuitry is configured to receive, from the one or more further sound processing devices, the one or more local adjustments to the sound processing model determined by the one or more further sound processing devices based on sound recorded locally by the one or more further sound processing devices, e.g., as contribution of the respective one or more helper devices to the distributed learning scheme, e.g., as changes in parameter values of the set of audio filters or as changed weights of a neural network.

The processing circuitry of the main device may evaluate the local adjustments proposed by the one or more helper devices, e.g., to determine whether the respective changes are useful for processing the sound recorded by the main device. For example, the processing circuitry of the main device may be configured to determine a usefulness of the one or more local adjustments for the sound processing device (e.g., for the purpose of performing the sound processing task). Depending on the usefulness of the one or more local adjustments, they may be applied to the sound processing model. For example, depending on the distributed learning scheme being used, the contributions of the one or more helper devices may be used to adjust the sound processing model according to the respective distributed learning scheme.

In general, a soundscape can change quickly, as people and objects move relative to each other, and as new sound sources appear, or previous sound sources cease emitting sound. Therefore, the sound processing model may be continuously adapted to the evolving soundscape. This may be done by not only receiving a single local adjustment per helper device, but by receiving (frequent) updates from the one or more helper devices. For example, the processing circuitry of the helper device may be configured to repeatedly (e.g., periodically, or when the soundscape changes, or both) determine updates to the local adjustment to the sound processing model based on newly recorded sound recorded by the sound processing device, and to provide the updates to the further sound processing device. In general, these updates may be provided frequently, so the main device can adapt the sound processing model to the changing sound scape. For example, a time interval between successive updates to the local adjustment may be at most fifteen seconds (or at most 10 seconds, or at most 5 seconds, or at most 1 second, or at most 100 ms, or at most 50 ms), which may depend on the task being performed. For example, for the purpose of real-time or near-real-time voice processing, update intervals of at most 100 ms (or at most 50 ms) may be desirable, to enable frequent updates to the sound processing model. On the side of the main device, the processing circuitry of the main device is configured to repeatedly receive updates to the one or more local adjustments from at least a subset (deemed to provide useful local adjustments) of the one or more further sound processing devices. The main device may use these updates to update the sound processing model accordingly. For example, the processing circuitry of the main device may be configured to repeatedly adjust the sound processing model based on the repeatedly received updates to the one or more local adjustments.

In some cases, helper devices that were initially deemed to provide useful adjustments may become less useful over time, e.g., as sound sources cease to emit sound, or as the respective devices move relative to each other. Accordingly, the main device may update the list (or graph) of helper devices it requests and receives updates (i.e., subscribes to updates) from. For example, the processing circuitry of the main device may be configured to ignore or cease receiving updates from another sound processing device based on the usefulness of the local adjustment of the other sound processing device for the sound processing device. On the other hand, the processing circuitry of the main device may be configured to add additional helper devices (it requests local adjustments from) over time, e.g., based on them being in the same general location.

Using the adjusted sound processing model, the main device processes the sound recorded locally by the main device. For example, the processing circuitry of the main device may be configured to perform real-time processing or near-real-time processing (e.g., with a delay of at most 5 seconds (or at most 2 seconds, or at most 1 second) between recording and processing of the sound) of the sound recorded by the sound processing device using the sound processing model.

In various examples of the present disclosure, the main device and the helper devices may collaborate in a privacy-preserving manner. This may be done on two levels—as part of the communication, and as part of the local adjustments and or sample of sound shared by the helper devices and main device, respectively.

With respect to communication privacy, the techniques listed as part of the “privacy (communication) layer” shown in connection with FIG. 3 may be used.

With respect to data privacy, the techniques listed as part of the “privacy (signal) layer” shown in connection with FIG. 3 may be used. In particular, the following two general techniques may be used to improve the privacy of the helper devices—privacy-preserving embeddings, and differential privacy. When using privacy-preserving embeddings, the sound being used to determine the respective local adjustment is pre-processed in order to remove features that could violate privacy, such as voices that can be heard in the vicinity of the respective helper device, or the location of the helper device. Accordingly, the one or more local adjustments may be based on one or more embeddings designed to alter at least one aspect of the sound recorded locally, such as an impact of local speech or an impact of a location of the respective further sound processing device. The respective helper devices may apply those embeddings on the sound recorded locally to preserve privacy. For example, the processing circuitry of the helper device may be configured to apply one or more embeddings designed to alter at least one aspect of the sound recorded locally, such as an impact of local speech or an impact of a location of the respective further sound processing device. For example, a static or collaboratively learned speech suppression filter may be used to suppress the impact of local speech. With respect to the location, a simulated displacement of a microphone of the helper device may be applied to rescale signal components of the respective sound recorded by the helper device.

Additionally, or alternatively, differential privacy may be used. For example, a privacy budget of a differential privacy algorithm may be used to control how often the helper device provides an update to the local adjustment (or whether the helper device agrees to provide a local adjustment) or to control whether to apply a privacy-preserving embedding. For example, the processing circuitry of the helper device may be configured to determine the local adjustment based on a privacy budget of a differential privacy algorithm. Accordingly, the one or more local adjustments may be based on a privacy budget imposed by a differential privacy algorithm.

In some cases, not all of the helper devices (or main devices) may be considered to be trustworthy (or useful). For example, some helper devices may have malicious intent, and may try to poison the distributed learning, while some main devices might try to only benefit from distributed learning, without contributing to the distributed learning of other devices. As will be described in connection with FIG. 3, a verification layer may be used to validate device honesty, thereby vetting the main device or helper devices, respectively, before participating in the distributed learning scheme.

In the above description, a single sound processing model was mentioned that is being used to process the sound recorded by the main device. However, the proposed concept is not limited to a single sound processing model. The main device may use multiple sound processing models to process the sound recorded by the main device. For example, the processing circuitry of the main device may be configured to process the sound recorded locally using the sound processing model (further also denoted first sound processing model or task-agnostic sound processing model) and using a second sound processing model. The sound processing model may be a task-agnostic sound processing model and the second sound processing model being a task-specific sound processing model. For example, the sound processing model may be the base model, with the second source processing model being applied on top of the first sound source processing model. The first sound processing model being task-agnostic means that it may be suitable for different tasks (as it handles generic aspects, such as the removal of noise). The first sound processing model may then be combined with the second sound processing model, which is a task-specific model (i.e., a model that is specific to a single sound processing task), and which might not be adjusted based on the local adjustments provided by the one or more helper devices. However, the main device may attempt to improve the second sound processing model without input from the one or more helper devices.

In some examples, the layer stack may be extended by a third sound processing model (being inserted between the first and second sound processing model). For example, the processing circuitry of the main device may be configured to process the sound recorded locally further using a third sound processing model. This third sound processing model may be task-specific sound processing model, and it may be improved or optimized using distributed learning with the help of the one or more helper devices. For example, the processing circuitry of the helper device may be configured to obtain a task-specific sound processing model (i.e., the third sound processing model), to determine a further local adjustment to the task-specific sound processing model based on the sound recorded locally by the sound processing device (similar to the determination of the local adjustment), and to provide the further local adjustment to the further sound processing device. For example, the helper device may use the sample of sound provided by the main device and the sound recorded locally by the helper device to determine the further local adjustment to the third sound processing model. Accordingly, the processing circuitry of the main device may be configured to receive, from the one or more further sound processing devices, one or more further local adjustments to the third sound processing model determined by the one or more further sound processing devices based on sound recorded locally by the one or more further sound processing devices, and to adjust the third sound processing model based on the one or more further local adjustments. For example, the determination of the local adjustments, updates to the local adjustments, and adjustment of the third sound processing model may be implemented similar to the respective aspects of the (first) sound processing model.

The at least one interface 12; 22 of the main device 10 and/or the helper device 20 may correspond to one or more inputs and/or outputs for receiving and/or transmitting information, which may be in digital (bit) values according to a specified code, within a module, between modules or between modules of different entities. For example, the at least one interface 12; 22 of the main device 10 and/or the helper device 20 may comprise interface circuitry configured to receive and/or transmit information. For example, the main device 20 and/or the one or more helper devices 20 (and/or the central registry) may be configured to communicate via a computer network, e.g., via a mobile communication system, such as a cellular mobile communication system (being based on a standard defined by the 3′1-Generation Partnership Project, 3GPP, such as Long Term Evolution or a 5th Generation (5G) cellular mobile communication system, or a mobile communication system being based on Bluetooth or a variant of the IEEE (Institute of Electrical and Electronics Engineers) standard 802.11.

For example, the processing circuitry 14; 24 of the main device 10 and/or the helper device may be implemented using one or more processing units, one or more processing devices, any means for processing, such as a processor, a computer or a programmable hardware component being operable with accordingly adapted software. In other words, the described function of the processing circuitry 14; 24 of the main device 10 and/or the helper device 20 may as well be implemented in software, which is then executed on one or more programmable hardware components. Such hardware components may comprise a general-purpose processor, a Digital Signal Processor (DSP), a micro-controller, etc.

For example, the storage circuitry 16; 26 of the main device 10 and/or helper device 20 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the sound processing devices 10; 20 and of the corresponding systems, devices 100; 200, methods and computer programs are mentioned in connection with the proposed concept, or one or more examples described above or below (e.g., FIGS. 3 to 5b). The sound processing devices 10; 20 and of the corresponding systems, devices 100; 200, methods and computer programs may comprise one or more additional optional features corresponding to one or more aspects of the proposed concept, or one or more examples described above or below.

Various aspects of the present disclosure relate to a concept for a privacy-preserving, crowdsourced decomposition of soundscape. A system is proposed where (devices of) willing participants can, in a privacy preserving manner, perform collaborative machine learning with the purpose of building a (potentially task-agnostic) encoder. For example, the proposed system may be used for collaborative reconstruction of 3D soundscapes, selective noise cancelling, helping with disabilities (hearing loss), or improving voice recognition systems. Various examples of the proposed system support near-real-time to real-time inference depending on the setup and task (e.g., for speech, a latency below 50 ms may be achieved).

FIG. 3 shows a schematic diagram of an example of a distributed learning approach applied on sound processing devices. FIG. 3 shows a high-level abstract of an example of the proposed concept. As shown in FIG. 3, various examples are based on three components—a directed network of contributors 310 (i.e., the main device 10 and the one or more helper devices 20), a (privacy-preserving) distributed learning strategy 320, and a model 330 (i.e., the sound processing model) that is common to the whole network.

In the example of FIG. 3, each device of the directed network of contributors chooses which node (device, e.g., helper device) of the network to pull data from according to its local task (which can be different for each device). Then, the devices may negotiate a data exchange policy before establishing the connection. This results in a dynamic, directed graph of contributions.

In order to improve or optimize the model associated with the current environment, the devices exchange information according to a distributed learning algorithm (as part of the privacy-preserving learning strategy 320). In addition, each participant may improve or optimizes which participants he takes information from in order to minimize processing time and increase or maximize performance on his task.

Each device may perform a task which is either improved or accelerated having access to a global encoding model (i.e., the sound processing model). For example, the model may be applied on audio signals 332, 334 and 336 emitted in a first location, in a second location and emitted in a third location. The encoder itself depends on the use case. It (i.e., the sound processing model) may be a function mapping raw sensor inputs to privacy preserving data.

The proposed concept may be implemented in different ways. In the following, examples of high-level implementations of the different communication components and signal processing components are given.

First, examples are given with respect to the components (layers) responsible for communication-related features of the proposed concept. The device network (of sound processing devices) can be setup with or without the presence of a trusted server (i.e., the central registry) facilitating the communication, enabling both centralized and decentralized implementations.

In various examples, a (centralized or decentralized) registry layer may be used, which is a repository of device metadata used to setup the communication network as well as assess device collaboration opportunities. In a centralized implementation, (all of) the devices register in a central server (i.e., the central registry) and publish there the required information to participate in the network. When a user becomes active on the network, it registers to the central server which manages a registry of devices/users. In a decentralized implementation, a peer-to-peer local network may be used. In this implementation, each device keeps track of devices open to collaborate in its vicinity.

The devices may use a subscription layer, which manages communications between the devices. In a centralized implementation, centralized communication may be used (i.e., (all) communication may be routed by (or via) a central server. In a decentralized implementation, a peer-to-peer local network may be used, and communication channels may be opened between trusted devices in a publisher-subscriber fashion. In a broadcasting implementation, the respective data (e.g., the sound processing model, the information on the task and/or the local adjustments) may be broadcast by the participants or by the infrastructure. Contributions of individual recording devices (i.e., sound processing devices) may be broadcast in a localized area. Users can cherry-pick (i.e., select among) the broadcast packets.

In some examples, a verification layer may be used, to validate device honesty (data contributions as well as well subscription behavior). In a centralized implementation, a trusted third part may play the role of validating devices that desire to participate in the local network. This can be done in various ways with cryptographic certificates distributed to trusted agents, and/or by continuous verification of each device behavior on the network. In a decentralized implementation, a trustless network may be used. For example, if no trusted third party exists, each device can monitor the contribution of the devices

For example, a privacy (communication) layer may be used, to increase the privacy for the communication layers (excluding actual data privacy). In a centralized implementation, a curious but honest third party may be used. In the case where the central server is not malicious but is curious, local privacy may be preserved. Standard encryption techniques can be used for communications. The registry can store temporary session IDs instead of permanent device IDs. If the verification layer requires decryption of the content of the shared data, a secure enclave can be setup in collaboration with each participating device. In a decentralized implementation, local privacy may be used. In this setting, privacy leakage can happen like with Bluetooth. It is possible to mitigate it by using various obfuscation techniques, but not to fully prevent it as users can potentially see each other physically and reverse engineer the obfuscation.

In the following, examples are given with respect to the signal processing components. For example, high-level components (layers) responsible for the security and processing of signals are described.

For example, the devices may use an embedding layer, which extracts the necessary information (and only the necessary information) from the current device actual recording (i.e., the sound recorded locally by the respective devices). For example, it can comprise or consist of a basic band pass filter, up to a deep neural network. Its output is pushed to subscribers (e.g., used to determine the local adjustments).

The devices may use a privacy (signal) layer, which may remove (any) privacy sensitive information from the embedding layer. It can be put on top of the embedding layer, with, for instance, differential privacy or cryptographic methods (e.g., distributed learning with Multi-Party Computation), or integrated in it, for instance using adversarial learning.

For example, a reconstruction layer may be used to model the recorded signal using all the embeddings received from participating devices. It can for instance model the signal as a sum of incoherent labelled components. It may optionally contain a forecasting model aiming at real-time reconstruction.

A learning layer may manage the collaborative learning of the embedding and reconstruction layers. For example, the learning layer may subscribe to new recording devices if they appear from their metadata to be potentially helpful and may unsubscribe from the devices which are redundant or do no show signs of overlapping with the locally recorded signal. It may improve/calibrate the embedding and reconstruction layers, e.g., using master-less distributed learning like MPC (Multi-Party Computation) or fully decentralized learning. If a centralized embodiment is chosen, Federated Learning may be used.

FIG. 4 shows a schematic diagram of an example of a spatial relationship between sound sources and sound processing devices. FIG. 4 gives an example with respect to an audio setting. FIG. 4 shows four sound sources 410; 420; 430; 440 and four sound processing devices 450; 460; 470; 480 with microphones. The sound sources 410 and 420 can easily be distinguished if the sound processing devices 450 and 460 collaborate. In the presence of background noise 430, a third sound processing device 470 can be recruited to suppress it. In order to be able to perform these operations, sound processing devices 450 and 460 may compare their signals in a privacy preserving fashion.

In addition, a sound processing device (e.g., recording device, main device) may be able to recruit a new device in order to increase the accuracy of the task at hand. In this example, devices 450 and 460 can try to isolate sources 410 and 420 while suppressing source 430. Because the device 470 has a strong recording of the background with only a weak contribution of 410 and 420, it can be used to suppress source 430.

In addition, it is possible that another source of noise 440, outside of the range of 410 and 420, is interfering with the recording of 470. However, if 480 participates in the soundscape reconstruction of the device 470, 410 and 420 (or 450/460) can indirectly benefit from it.

FIG. 5a shows a flow chart of an example of a setup process for distributed learning. FIGS. 5a and 5b show three entities, a registry (A) 510, which may be local or remote to device A 520, device A 520 (e.g., the main device), and device B 530 (e.g., a helper device). At (1), a task is started on device A. At (2), device A 520 queries registry 510 for useful models, (potential) helper devices 530 and respective contribution data. Query data can contain information such as authentication information, a task identifier, location information, a labelled (anonymized) sample, etc. At (3), the registry 510 assesses a validity of the query and returns pertinent results. It can consider a history of models, contributors, and related data to do so. At (4), device A 520 selects a base model (i.e., the sound processing model) and desired contributors (e.g., the one or more helper devices, including device B 530). At (5), device A applies to receive data from device B regarding the selected model. At (6), optionally, a negotiation is conducted between device A and device B on policy for Device A data access. The negotiation concerns which data will device A be allowed to subscribe to. This negotiation can involve a trade with Device B. Standard cryptographic techniques can be used to enforce the agreement, say through an intermediary smart-contract. The requested data can contain model updates, (labelled, anonymized) examples or embeddings, etc. At (7), Device B provides device A subscription keys to the agreed upon data stream (of local adjustments).

FIG. 5b shows a flow chart of an example of a training process for distributed learning. At (1) device B computes latest model parameters (e.g., a local adjustment to the model). At (2), device B makes the required data (e.g., the local adjustment) available to device A. At (3), device A integrates data in its own model update. The model lifetime should match its update time in order to function correctly. For example, the model may be split in an anonymized core model (generating for instance embeddings) and a personal model which can be updated more frequently (e.g., in relation to an accelerometer in the device). At (4), device A may periodically commit the new anonymized model and related data to the registry. Trends of contribution of helper devices may be analyzed to eventually terminate the subscription. At (5) If the subscription did not expire, Device A can terminate the subscription to the data stream of device B data stream.

The same process may be used with a single batch of data being shared from Device B to Device A to populate the registry. This can be included in (6) of the setup process shown in FIG. 6.

In the following, an application of the proposed concept on hearing aids is shown. In this application of the proposed concept, the hearing aids may be helped by family and friends' phones.

In the following, the hearing aids (HA) are assumed to be the main device, which is assisted by the helper devices (HD).

The HAs may be one or more devices that have the task of providing hearing aid with improved signal/noise ratio (e.g., by decreasing reverberation), ability to focus attention to specific sound sources. They may also have the task of creating a small dataset that helper devices can use to train an initial model in combination with their own recording.

The HDs may have the task of processing the recorded audio and collaboratively creating the reconstruction model. They may create a small size training dataset that the hearing aids can use to calibrate their local model.

The model should be typically stable on a period of a few tenths of seconds to up to a few seconds and should allow low-latency inference. It may comprise or consist of a list of labelled audio filters, for example.

The following improvement or optimization strategy may be used. For initialization, the HA generate may generate an initial 3D model (e.g., based to microphones situated on each earpiece). For the purpose of distribution, the HD(s) may asynchronously pull the current model and fresh sample data from the HA. Updates may be performed asynchronously on each HD based on utility and/or task parameters. The HD may compare the HA sample data with buffered audio recorded locally and update the model accordingly. The HD may propose model updates (i.e., a local adjustment) to the HA. The HA may consider the update to the model and may report new ratings to the HD.

Alternatively, the hearing aids may be helped by an anonymous crowd. In this case, the previously described implementation example may be extended with additional privacy measures. In the following, the difference to the previously described example is described.

In this case, when providing the model (updates) and sample dataset, the devices may have the task of protecting or guaranteeing the anonymity of the subject in range of the microphone. In order to protect or guarantee sample anonymity, embeddings can be used that suppress speech and randomize implicit location. The speech suppression filter may be common to all collaborating devices. It can be a pre-trained static filter but can also be collaboratively learned using decentralized adversarial learning, each device using the raw locally recorded audio as training set. The removal of the location embedded in the audio signal may be equivalent to resealing the signal components to simulate a “displacement” of the microphone (note that this transformation can correspond to impossible positions without complication). A random location may be selected initially and preserved throughout the learning. The transformation of the speech-free signal to the fully anonymized signal may be stored locally by each device.

The model being used may be (made) location agnostic to avoid localization of the HA and allow multiple HA to participate. Filters may be defined on anonymized (speech-free, location-free) embeddings

Incentives may be orchestrated using trusted services. Alternatively, a trustless approach can be adopted, as for instance a blockchain-based system. Due to the computationally intensive aspect of such protocol, it might not be used during the contribution. Information may be gathered locally, and reward may be computed afterward based on aggregated contribution metrics. This means devices may still need to be trusted to compute those metrics accurately.

With respect to security and communications, corrupted participants may be warranted against using anomaly detection and/or cryptographic measures. For communications, standard networking techniques may be, assuming the shared data is fully anonymized (as shown in connection with the communication components outlined above). The same improvement or optimization strategy may be used as in the case, where the hearing aids are helped by family and friends' phones

More details and aspects of the concept for a privacy-preserving, crowdsourced decomposition of soundscape are mentioned in connection with the proposed concept, or one or more examples described above or below (e.g., FIG. 1a to 2b). The concept for a privacy-preserving, crowdsourced decomposition of soundscape may comprise one or more additional optional features corresponding to one or more aspects of the proposed concept, or one or more examples described above or below.

In the following, some examples of the proposed concept are presented:
(1) A sound processing device 10, comprising:
   at least one interface 12 for communicating with one or more further sound processing devices 20; and
   processing circuitry 14, configured to:
   obtain a sound processing model,
   receive, from the one or more further sound processing devices, one or more local adjustments to the sound processing model determined by the one or more further sound processing devices based on sound recorded locally by the one or more further sound processing devices,
   adjust the sound processing model based on the one or more local adjustments, and
   process sound recorded locally by the sound processing device using the sound processing model.
(2) The sound processing device according to (1), wherein the processing circuitry is configured use the sound processing model to perform a sound processing task, with the processing circuitry being configured to provide information on the sound processing task to the one or more further sound processing devices, and the one or more local adjustments begin determined based on the sound processing task.
(3) The sound processing device according to one of (1) or (2), wherein the processing circuitry is configured to repeatedly receive updates to the one or more local adjustments from at least a subset of the one or more further sound processing devices.
(4) The sound processing device according to (3), wherein a time interval between successive updates to the one or more local adjustments is at most fifteen seconds.
(5) The sound processing device according to one of (3) or (4), wherein the processing circuitry is configured to repeatedly adjust the sound processing model based on the repeatedly received updates to the one or more local adjustments.
(6) The sound processing device according to one of (3) to (5), wherein the processing circuitry is configured to determine a usefulness of the one or more local adjustments for the sound processing device, and to ignore or cease receiving updates from another sound processing device based on the usefulness of the local adjustment of the other sound processing device for the sound processing device.
(7) The sound processing device according to one of (1) to (6), wherein the processing circuitry is configured to perform real-time processing or near-real-time processing of the sound recorded by the sound processing device using the sound processing model.
(8) The sound processing device according to one of (1) to (7), wherein the processing circuitry is configured to obtain the sound processing model from a central registry.
(9) The sound processing device according to one of (1) to (8), wherein the processing circuitry is configured to obtain the sound processing model from another sound processing device,
   or wherein the processing circuitry is configured to generate the sound processing model,
   and/or or wherein the processing circuitry is configured to provide the sound processing model to the one or more further sound processing devices.
(10) The sound processing device according to one of (1) to (9), wherein the processing circuitry is configured to provide one or more requests to the one or more further sound processing devices to provide the one or more local adjustments and/or the sound processing model.
(11) The sound processing device according to (10), wherein the processing circuitry is configured to obtain information on a presence of sound processing devices in a general location of the sound processing device from a central registry, and to provide the one or more requests based on the information on the presence of the sound processing devices in the general location of the sound processing device.
(12) The sound processing device according to (10), wherein the processing circuitry is configured to determine a presence of the one or more further sound processing devices in a general location of the sound processing device, and to provide the one or more requests based on the determination of the presence of the one or more further sound processing devices.
(13) The sound processing device according to one of (1) to (12), wherein the processing circuitry is configured to perform distributed learning using the one or more local adjustments to adjust the sound processing model.
(14) The sound processing device according to one of (1) to (13), wherein the one or more local adjustments are based on one or more embeddings designed to alter at least one aspect of the sound recorded locally, such as an impact of local speech or an impact of a location of the respective further sound processing device.
(15) The sound processing device according to one of (1) to (14), wherein the one or more local adjustments are based on a privacy budget imposed by a differential privacy algorithm.
(16) The sound processing device according to one of (1) to (15), wherein the processing circuitry is configured to process the sound recorded locally using the sound processing model and using a second sound processing model, with the sound processing model being a task-agnostic sound processing model and the second sound processing model being a task-specific sound processing model.
(17) The sound processing device according to (16), wherein the processing circuitry is configured to process the sound recorded locally further using a third sound processing model, with the third sound processing model being a task-specific sound processing model, and with the processing circuitry being configured to receive, from the one or more further sound processing devices, one or more further local adjustments to the third sound processing model determined by the one or more further sound processing devices based on sound recorded locally by the one or more further sound processing devices, and to adjust the third sound processing model based on the one or more further local adjustments.
(18) A sound processing device 20, comprising:
   at least one interface 22 for communicating with a further sound processing device 10; and
   processing circuitry 24, configured to:
   obtain a sound processing model,
   obtain information on a sound processing task being performed by the further sound processing device,
   determine a local adjustment to the sound processing model based on sound recorded locally by the sound processing device and based on the sound processing task being performed by the further sound processing device,
   provide the local adjustment to the further sound processing device.
(19) The sound processing device according to (18), wherein the processing circuitry is configured to repeatedly determine updates to the local adjustment to the sound processing model based on newly recorded sound recorded by the sound processing device, and to provide the updates to the further sound processing device.
(20) The sound processing device according to (19), wherein a time interval between successive updates to the local adjustment is at most fifteen seconds.
(21) The sound processing device according to one of (18) to (20), wherein the processing circuitry is configured to obtain the sound processing model from a central registry,
   or wherein the processing circuitry is configured to obtain the sound processing model from another sound processing device.
(22) The sound processing device according to one of (18) to (21), wherein the processing circuitry is configured to receive a request for the local adjustment from the further sound processing device, and to provide the local adjustment in response to the request.
(23) The sound processing device according to one of (18) to (22), wherein the determination of the local adjustment is part of distributed learning.
(24) The sound processing device according to one of (18) to (23), wherein the processing circuitry is configured to apply one or more embeddings designed to alter at least one aspect of the sound recorded locally, such as an impact of local speech or an impact of a location of the respective further sound processing device.
(25) The sound processing device according to one of (18) to (24), wherein the processing circuitry is configured to determine the local adjustment based on a privacy budget of a differential privacy algorithm.
(26) The sound processing device according to one of (18) to (25), wherein the sound processing model is a task-agnostic sound processing model, the processing circuitry being configured to obtain a task-specific sound processing model, to determine a further local adjustment to the task-specific sound processing model based on the sound recorded locally by the sound processing device, and to provide the further local adjustment to the further sound processing device.
(27) A hearing aid 100 comprising the sound processing device 10 according to one of (1) to (17).
(28) A hearing aid 200 comprising the sound processing device 20 according to one of (18) to (26).
(29) A mobile communication device 100 comprising the sound processing device according to one of (1) to (17).
(30) A mobile communication device 200 comprising the sound processing device according to one of (18) to (26).
(31) A method for a sound processing device, the method comprising:
   obtaining 110 a sound processing model;
   receiving 120, from one or more further sound processing devices, one or more local adjustments to the sound processing model performed by the one or more further sound processing devices based on sound recorded locally by the one or more further sound processing devices;
   adjusting 130 the sound processing model based on the one or more local adjustments; and
   processing 140 sound recorded locally by the sound processing device using the sound processing model.
(32) A method for a sound processing device, the method comprising:
   obtaining 210 a sound processing model;
   obtaining 220 information on a sound processing task being performed by a further sound processing device;
   determining 230 a local adjustment to the sound processing model based on sound recorded locally by the sound processing device and based on the sound processing task being performed by the further sound processing device; and
   providing 240 the local adjustment to the further sound processing device.
(33) A computer program having a program code for performing the method of (31), when the computer program is executed on a computer, a processor, or a programmable hardware component.
(34) A computer program having a program code for performing the method of (32), when the computer program is executed on a computer, a processor, or a programmable hardware component.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

Various examples of the present disclosure are based on using a machine-learning model or machine-learning algorithm. Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and associated training content information, the machine-learning model “learns” to recognize the content of the images, so the content of images that are not included of the training images can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model.

Machine-learning models are trained using training input data. The examples specified above use a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm, e.g., a classification algorithm, a regression algorithm, or a similarity learning algorithm. Classification algorithms may be used when the outputs are restricted to a limited set of values, i.e., the input is classified to one of the limited set of values. Regression algorithms may be used when the outputs may have any numerical value (within a range). Similarity learning algorithms are similar to both classification and regression algorithms but are based on learning from examples using a similarity function that measures how similar or related two objects are.

Apart from supervised or semi-supervised learning, unsupervised learning may be used to train the machine-learning model. In unsupervised learning, (only) input data might be supplied, and an unsupervised learning algorithm may be used to find structure in the input data, e.g., by grouping or clustering the input data, finding commonalities in the data. Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Machine-learning algorithms are usually based on a machine-learning model. In other words, the term “machine-learning algorithm” may denote a set of instructions that may be used to create, train, or use a machine-learning model. The term “machine-learning model” may denote a data structure and/or set of rules that represents the learned knowledge, e.g., based on the training performed by the machine-learning algorithm. In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of the sum of its inputs. The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e., to achieve a desired output for a given input. In at least some embodiments, the machine-learning model may be deep neural network, e.g., a neural network comprising one or more layers of hidden nodes (i.e., hidden layers), prefer-ably a plurality of layers of hidden nodes.

Alternatively, the machine-learning model may be a support vector machine. Support vector machines (i.e., support vector networks) are supervised learning models with associated learning algorithms that may be used to analyze data, e.g., in classification or regression analysis. Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A sound processing device, comprising:
at least one interface for communicating with one or more further sound processing devices; and
processing circuitry, configured to:
obtain a sound processing model,
receive, from the one or more further sound processing devices, one or more local adjustments to the sound processing model determined by the one or more further sound processing devices based on sound recorded locally by the one or more further sound processing devices,
adjust the sound processing model based on the one or more local adjustments, and process sound recorded locally by the sound processing device using the sound processing model.

2. The sound processing device according to claim 1, wherein the processing circuitry is configured use the sound processing model to perform a sound processing task, with the processing circuitry being configured to provide information on the sound processing task to the one or more further sound processing devices, and the one or more local adjustments begin determined based on the sound processing task.

3. The sound processing device according to claim 1, wherein the processing circuitry is configured to repeatedly receive updates to the one or more local adjustments from at least a subset of the one or more further sound processing devices.

4. The sound processing device according to claim 3, wherein the processing circuitry is configured to repeatedly adjust the sound processing model based on the repeatedly received updates to the one or more local adjustments.

5. The sound processing device according to claim 3, wherein the processing circuitry is configured to determine a usefulness of the one or more local adjustments for the sound processing device, and to ignore or cease receiving updates from another sound processing device based on the usefulness of the local adjustment of the other sound processing device for the sound processing device.

6. The sound processing device according to claim 1, wherein the processing circuitry is configured to perform real-time processing or near-real-time processing of the sound recorded by the sound processing device using the sound processing model.

7. The sound processing device according to claim 1, wherein the processing circuitry is configured to obtain the sound processing model from a central registry.

8. The sound processing device according to claim 1, wherein the processing circuitry is configured to obtain the sound processing model from another sound processing device,
or wherein the processing circuitry is configured to generate the sound processing model,
and/or or wherein the processing circuitry is configured to provide the sound processing model to the one or more further sound processing devices.

9. The sound processing device according to claim 1, wherein the processing circuitry is configured to provide one or more requests to the one or more further sound processing devices to provide the one or more local adjustments and/or the sound processing model.

10. The sound processing device according to claim 9, wherein the processing circuitry is configured to obtain information on a presence of sound processing devices in a general location of the sound processing device from a central registry, and to provide the one or more requests based on the information on the presence of the sound processing devices in the general location of the sound processing device.

11. The sound processing device according to claim 9, wherein the processing circuitry is configured to determine a presence of the one or more further sound processing devices in a general location of the sound processing device, and to provide the one or more requests based on the determination of the presence of the one or more further sound processing devices.

12. The sound processing device according to claim 1, wherein the processing circuitry is configured to perform distributed learning using the one or more local adjustments to adjust the sound processing model.

13. The sound processing device according to claim 1, wherein the one or more local adjustments are based on one or more embeddings designed to alter at least one aspect of the sound recorded locally, such as an impact of local speech or an impact of a location of the respective further sound processing device.

14. The sound processing device according to claim 1, wherein the one or more local adjustments are based on a privacy budget imposed by a differential privacy algorithm.

15. The sound processing device according to claim 1, wherein the processing circuitry is configured to process the sound recorded locally using the sound processing model and using a second sound processing model, with the sound processing model being a task-agnostic sound processing model and the second sound processing model being a task-specific sound processing model.

16. A sound processing device, comprising:
at least one interface for communicating with a further sound processing device; and
processing circuitry, configured to:
obtain a sound processing model,
obtain information on a sound processing task being performed by the further sound processing device,
determine a local adjustment to the sound processing model based on sound recorded locally by the sound processing device and based on the sound processing task being performed by the further sound processing device,
provide the local adjustment to the further sound processing device.

17. A method for a sound processing device, the method comprising:
obtaining a sound processing model;
receiving, from one or more further sound processing devices, one or more local adjustments to the sound processing model performed by the one or more further sound processing devices based on sound recorded locally by the one or more further sound processing devices;
adjusting the sound processing model based on the one or more local adjustments; and
processing sound recorded locally by the sound processing device using the sound processing model.

18. A method for a sound processing device, the method comprising:
obtaining a sound processing model;
obtaining information on a sound processing task being performed by a further sound processing device;
determining a local adjustment to the sound processing model based on sound recorded locally by the sound processing device and based on the sound processing task being performed by the further sound processing device; and
providing the local adjustment to the further sound processing device.

19. A computer program having a program code for performing the method of claim 18, when the computer program is executed on a computer, a processor, or a programmable hardware component.

20. A computer program having a program code for performing the method of claim 19, when the computer program is executed on a computer, a processor, or a programmable hardware component.
